(19) United States
(12) Patent Application Publication
(10) Pub. No.: US 2009/0198707 A1
(43) Pub. Date: Aug. 6, 2009

(54) System and method for managing firewall log records

(75) Inventor: Aric V. Rohner, Raleigh, NC (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 12/012,926

(22) Filed: Feb. 6, 2008

(51) Int. Cl. G06F 17/30

(52) U.S. Cl. 707/100; 707/E17.009

(57) ABSTRACT

The present disclosure provides a method for managing communication records that includes receiving a plurality of firewall log records from at least a firewall system, consolidating the plurality of firewall log records by filtering out a plurality of duplicate records, and associating the plurality of firewall log records with a plurality of contexts to create a plurality of record-context combinations. The method also includes analyzing and storing the consolidated firewall log records, and producing at least one image file from the plurality of records-context combinations.

### BACKGROUND OF THE DISCLOSURE

A firewall is a dedicated system that may be located at an entry point of a private network. One of the primary functions of the firewall is to monitor and control the access from outside to the private network by allowing or denying access to the private network, based on a set of rules.

A firewall may generate a large amount of data, a large number of firewall log records. The firewall, functioning as a gatekeeper or a watchman, may check each access attempt and record the information related to the access attempt, information such as where the incoming packet came from, where it is going, and whether it has permission to go where it intends to go, etc.

### SUMMARY OF THE DISCLOSURE

According to one embodiment of the present disclosure, a method is provided that includes receiving a plurality of communication records from at least a firewall system, consolidating the plurality of firewall log records by filtering out a plurality of duplicate records, and associating the plurality of firewall log records with a plurality of contexts to create a plurality of record-context combinations. The method also includes analyzing and storing the consolidated firewall log records, and producing at least one image file from the plurality of records-context combinations.

According to another embodiment of the present disclosure, a system is provided that includes a memory operable to store a plurality of firewall log records, a plurality of contexts, and a plurality of network topology data. The system also includes one or more processors collectively operable to receive a plurality of firewall log records from at least a firewall system, consolidate the firewall log records by filtering out a plurality of duplicate records, and associate the plurality of firewall log records with a plurality of contexts to create a plurality of record-context combinations. The one or more processors are also collectively operable to analyze and store the consolidated firewall log records and produce and store at least one image file from the plurality of records-context combinations.

According to yet another embodiment of the present disclosure, a computer program embodied on a computer readable medium and operable to be executed by a processor is provided. The computer program includes computer readable program code for receiving a plurality of firewall log records from at least one firewall system, consolidating the firewall log records by filtering out a plurality of duplicate records, and associating the plurality of firewall log records with a plurality of contexts to create a plurality of record-context combinations. The computer program also includes computer readable program code for analyzing and storing the consolidated firewall log records, and producing at least one image file from the plurality of records-context combinations.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith.” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. The terms “firewall log record manager” and “firewall log record management system” refer to a software system, hardware system, or system that combines hardware and software components that can perform management related functions on a large number of firewall log records. The two terms and their equivalents may be used interchangeably throughout the disclosure. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in accordance with a disclosed embodiment;

FIG. 2 depicts a block diagram of an interconnected network including a firewall and a firewall log record manager;

FIG. 3 depicts a block diagram of a firewall log record manager coupled to a firewall, an image display system, and other systems in accordance with a disclosed embodiment;

FIG. 4 depicts a block diagram of a firewall log record manager in accordance with a disclosed embodiment;

FIG. 5 depicts a block diagram of a method for managing firewall log records in accordance with a disclosed embodiment; and

FIG. 6 shows an exemplary firewall log record summary in accordance with a disclosed embodiment.

### DETAILED DESCRIPTION

A large number of firewall log records may be generated by a firewall system as part of the firewall operation. The firewall log records in general are cryptic and difficult to understand. The present disclosure provides a system and a method to help a user interpret the cryptic firewall log records by filtering and associating firewall log records with appropriate contexts, analyzing the records, and creating images to allow the user to visualize the filtered firewall log records and the associated contexts. The firewall log records are used throughout this disclosure as an illustrative example and the methods and system described hereafter are applicable to generic communication records as well.

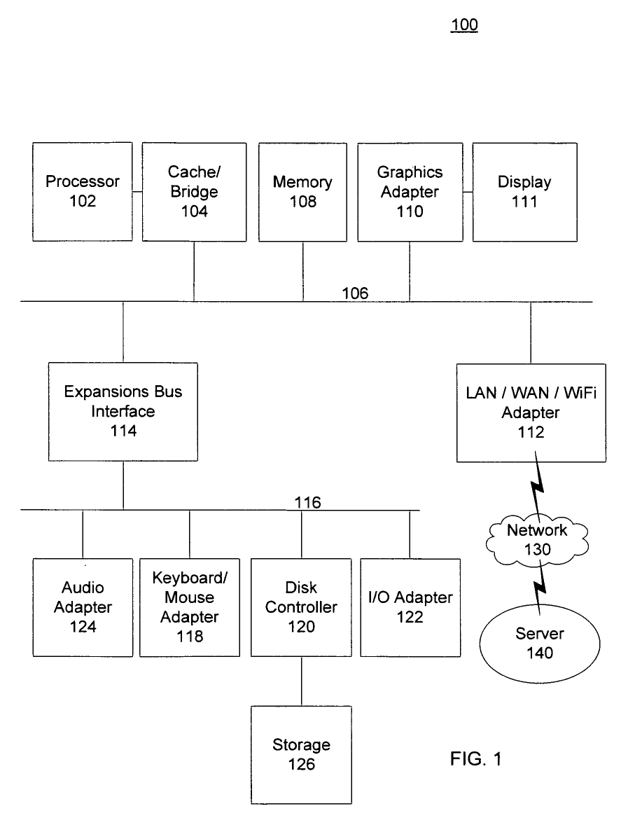

FIG. 1 through FIG. 6, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged device. The numerous innovative teachings of the present application will be described with reference to exemplary non-limiting embodiments.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMS) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, a trackball, and a trackpointer, etc.

Those of ordinary skill in the art will appreciate that the hardware depicted in FIG. 1 may vary for particular embodiments. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

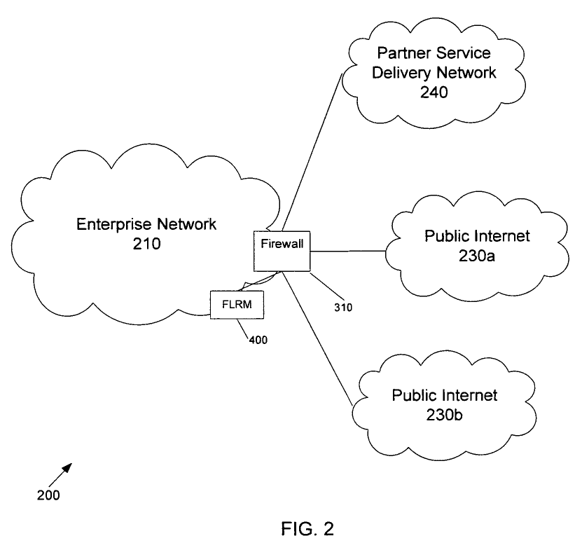

FIG. 2 depicts a block diagram of an interconnected network 200, in accordance with a disclosed embodiment. The interconnected network 200 includes an enterprise network 210, a partner service delivery network 240, a public Internet 230a, and a public Internet 230b. The enterprise network 210 is coupled to a firewall system 310, and a firewall log record manager (FLRM) system 400.

The enterprise network 210 can be a private network that belongs to an enterprise and that is interconnected to outside networks such as public Internet 230. The enterprise network 210 can also be connected to another private network such as the partner service delivery network 240. One example of such an interconnected network scenario is a bank network. The enterprise network 210 can belong, for example, to a bank and the enterprise network can be interconnected to one or more public IP networks so the bank customers can access their accounts on the bank network via the public Internet. The bank network can also be interconnected to a network belonging to a partner such as a financial transaction partner that can deliver financial transaction service to the bank customers. The enterprise network 210 that is exposed to the outside network has the firewall system 310 to monitor and control the accesses to the private enterprise network 210 from the outside networks.

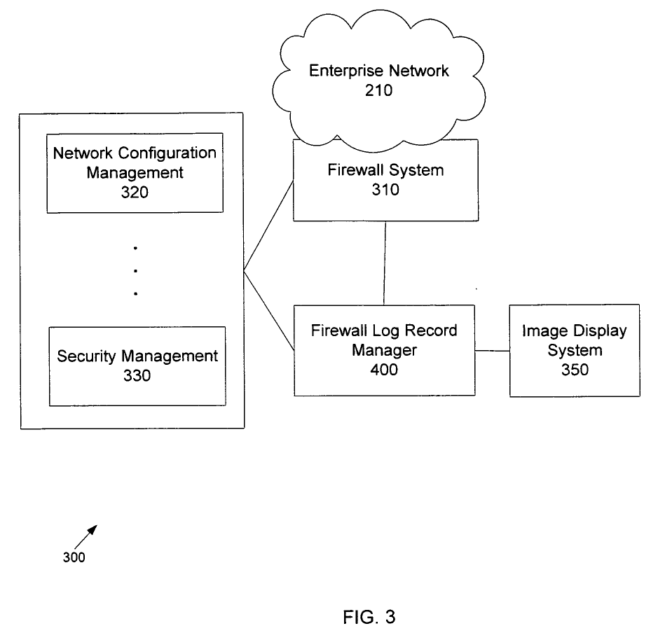

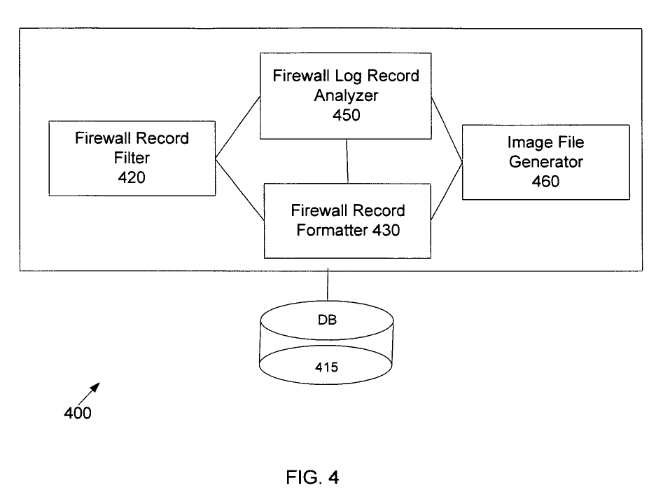

The firewall system 310 is generally situated at an entry point of the private enterprise network 210 as a gatekeeper and can be configured to filter incoming traffic and deny unsafe or unauthorized accesses by outside sources. The firewall system 310 can be implemented on a dedicated network node such as a high-speed router, and configured to process incoming traffic at a very high speed. The firewall system 310 can be coupled to a firewall log record manager (FLRM) 400, and the firewall log record manger 400 can help the user visualize the filtered firewall log records and the associated context. Both the firewall 310 and the firewall log record manger 400 are depicted in more details in FIG. 3 and FIG. 4 respectively and described thereinafter.

FIG. 3 depicts a block diagram of a combination 300 of a firewall log record manager 400 coupled to a firewall system 310, a network configuration management 320, a security management 330, and an image display system 350, in accordance with various disclosed embodiments. In other embodiments, the firewall log record manager 400 can be part of the firewall system 310. The firewall log record manager 400 can be coupled to additional or different systems, other than security management 330 and network configuration management 320. The embodiment of the combination of the firewall log record manager and other systems shown in FIG. 3 is for illustration only. Other embodiments of the combination may be used without departing from the scope of this disclosure.

The firewall system 310 is configured to control the flow of traffic, most notably the Internet traffic, into the coupled private enterprise network 210, and can be configured to perform other appropriate functions, as well. The firewall system 310 is generally a dedicated system including both hardware platform and software, situated at an entry point of the network 210, but can also be implemented as part of another hardware device, such as a DSL or cable modem, or in a data processing system 100. The firewall system 310 operates based on a set of security rules that specify whether an attempt to access the private network should be allowed or denied. The security rules may be based on a wide range of criteria such as the IP address of traffic source, type of the traffic, and the fact that whether or not the sender has been black listed, among others. The firewall system 310 in effect creates a security zone out of the private network it is responsible for protecting, and the security zone is also called demilitarized zone (DMZ).

The firewall log record manager 400 and the firewall system 310 can be coupled to the network configuration management 320 and the security management 330. The network configuration management 320 can supply the firewall log record manager 400 with the network configuration data for network contexts and network topological data for generating image files, among others. The network security management 330 can provide input data other than firewall alarm log records to the firewall log record manager 400, the additional input data such as data from the traffic monitoring tool sniffer, security monitoring tools, and a security intrusion detection system, among others. The security management 330 can also provide security rules that the firewall log record manager 400 can use for analyzing firewall log records. In another embodiment, the firewall log record manager 400 can be coupled to other systems such as a fault management system.

The image display system 350 can take as input one or more image files that are generated by the firewall log record manager 400. The image display system 350 can take image files in a variety of formats and present visual images to the user on a web browser, a stand-alone graphic display system, or other choices for displaying visual images.

FIG. 4 depicts a block diagram of a firewall log record manager or management system 400, in accordance with a disclosed embodiment. The firewall log manager 400 can include a firewall log record filter 420, a firewall log record formatter 430, a firewall log record analyzer 450, an image file generator 460, and a database 415. The embodiment of the firewall log record manager 400 shown in FIG. 4 is for illustration only. Other embodiments of the firewall log record manager 400 may be used without departing from the scope of this disclosure.

The firewall log record filter 420 is configured to filter out duplicate and abnormal firewall log records. The firewall log record filter 420 can receive input from the coupled firewall system 310. The input data can include firewall log records, network configuration data and security log data. The firewall log record filter can filter out duplicate records, “thin out” records, and merge the records, among other operations. Duplicate firewall log records can be received and identified using time stamp or other mechanisms. The firewall log records can be “thinned out” if fewer records are sufficient for an intended purpose such as a trend analysis. Multiple records can be received from multiple firewall systems or the same firewall system, and may need to be combined into fewer records. In another embodiment of the present disclosure, the firewall log record manager filter 420 can receive input data other than firewall log records, the input data such as monitoring data from a router, a switch, an intrusion detection system or the network traffic monitoring tool sniffer.

A firewall log record can include a variety of fields. Some examples of firewall log record fields can include a traffic source, a traffic destination, a network protocol used, application port, a time stamp for an access attempt, a count for the number of access attempts, and an action that is taken by the firewall system. The firewall log record can have an index field that can be a unique log record identifier, or a combination of a source IP address, a source port number, a destination IP address and a destination port number.

The firewall log record analyzer 450 can take as input the filtered firewall log records and perform analysis on the firewall log records. The firewall log record analyzer 450 can identify user network behavior such as attempts to connect to the network in a wrong or an unauthorized way. The firewall log record analyzer may also discover an application network configuration such as source IP address and port number, destination IP address and port number, and an application name. The firewall log record analyzer 450 can also analyze the firewall log records to identify a server network configuration such as name service, default interface, and routing, among others. The firewall log record analyzer 450 can discover network infrastructure service configuration such as DNS, time and routing. In addition, the firewall log record analyzer 450 can generate consolidated analysis reports to be presented to the user.

The firewall log record analyzer 450 can also associate firewall log records with appropriate contexts. A context is an environment in which the network access event corresponding to a firewall log record took place. In one embodiment of the present disclosure, the contexts are made of a network hierarchy, including a subnet context, a DMZ context, which may have one or more subnet contexts, a compartment context, which may have one or more DMZs, and un unknown context. Along with network configuration information, the context can help a user associate the firewall log record with a specific subnet, a network node, a related application, an application server, an organization, a network equipment, a network server, a domain name server, a host computer, and a user, among others.

The firewall log record formatter 430 can take filtered firewall log records as input from the firewall log record filter 420, or the firewall log record analyzer 450 or both, and formats the input records into a specific format for generating image files for display. In one embodiment of the present disclosure, the firewall log record-context combinations are converted into a DOT format file. DOT is a description language that allows descriptions of a network graph in terms of vertices and links.

The firewall log record formatter 430 can also provide mechanisms for representing the firewall log records and the associated contexts in terms of shapes and colors. In one embodiment of the present disclosure, an octagon shape is used to represent a context and a color to represent a specific context. For example, a white octagon may represent the subnet context, a green octagon the DMZ context, a blue octagon the compartment context, and a red octagon the unknown context. An oval shape may present a network node with a distinct IP address and a rectangle a host computer. A yellow oval and yellow rectangle may represent a network node and a host computer that are within the focus of analysis while a white oval and white rectangle may represent a network node and a host computer that are outside the focus of analysis. Links with a green color may represent traffic that has been allowed to pass by the firewall, and links with red color may represent traffic has been blocked by the firewall.

The image file generator 460 can take the output from the firewall log record analyzer 450, the firewall formatter log record formatter 430 or both and generate one or more image files suitable for display at the image display system 350. In one embodiment, the Graphviz® image generation tool produced by AT&T Corporation may be used to implement the image file generator 460.

The database (DB) 415, according to some embodiments of the current disclosure, can be implemented on a combination of the memory 108 and the data storage 126 of FIG. 1. The database 415 can be configured to store and manage the firewall log records, associated context data, and generated image files, among others. The database 415 can be implemented using a rational database, an object-oriented database, or a future database technology. The database 415 can be centrally located and distributed across multiple geographical areas, depending on the system design.

The firewall log record manager 400, either partially or in whole, may be implemented using a shell script language such as Bourn shell or a programming language such as the JAVA® programming language or the C++ programming language, or a combination of the two. The embodiment of the firewall log record manager 400 shown in FIG. 4 is for illustration only. Other embodiments of the firewall log record manager 400, which can have modules other than the firewall log record analyzer 450, the firewall log record filter 420, the firewall record formatter 430, and the image file generator 460, may be used without departing from the scope of this disclosure.

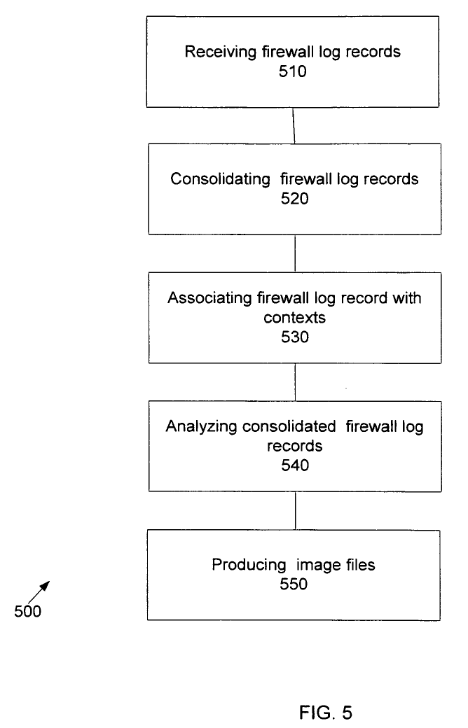

FIG. 5 depicts a block diagram of a method 500 for managing firewall log records, in accordance with a disclosed embodiment. The method 500 can include receiving firewall input data 510, filtering firewall log records 520, and associating firewall log records with appropriate contexts 530. The method 500 can also include analyzing firewall log records 540, formatting the firewall log records and generating image files 550.

The step of receiving input data 510 can include receiving firewall log records from the firewall system 310 and receiving network monitoring data from other system such as the security management system 330. The step of consolidating firewall log records 520 can include filtering the firewall log records, merging multiple records into fewer records, and generating a list of dropped firewall log records. Filtering the log records can include identifying and discarding duplicate records, and identifying and discarding abnormal log records. Identifying and discarding duplicate firewall log records can involve using time stamp, source and destination IP addresses and port numbers to compare log records and ascertain duplicate records. Identifying and discarding abnormal firewall log records can involve identifying those records that were generated as a result of a network condition or event that is outside the interests of the firewall log manager 400, the event such as a network link down. Merging multiple records can involve selecting one or more records that are sufficient to convey the information sought after and discarding other records. For example, only one firewall log record may be kept for multiple access attempts from the same destination port and IP address within a specified time period, such as one minute, while a count for the number of access attempts is kept. Generating a list of dropped firewall log records can involve recording the number of records that were dropped and the reasons for dropping the records.

The step of associating firewall log record data with contexts 530 can include searching for related context, obtaining the context and related information, and associating the firewall log record with the context and related information. Searching for the related context information can involve first searching for an index field and then searching for the network configuration database using the index field. Obtaining the context and related information can involve gathering different pieces of information from the configuration database and the firewall log records. For example, to obtain a subnet context, an IP address from the firewall log record is first obtained and then the subnet information can be obtained from the network configuration database using the IP address. Associating a firewall log record with the context can involve combining the obtained context information and related firewall log records, and creating a new firewall log record-context combination.

The step of analyzing consolidated firewall log records 540 can include identifying a behavior pattern, comparing access behavior against security rules, generating a summary report, and storing the firewall log record data. Identifying a behavior pattern can involve identifying the destination of the access attempt, the type of destination, and error type if there is an access error. Identifying behavior pattern can also include considering the number of access attempts, and the type of source address. For example, the source port can identify a HTTP application and a high number of repeated access attempts may indicate an access attempt for a security breach by an unauthorized party. A failed access attempt due to an incorrect IP address or an IP address mask may indicate a network configuration error. Generating a summary report may involve listing the related firewall log records, the associated contexts, and the analysis.

The step of producing image files 550 can include retrieving network configuration and topological data, retrieving annotation rules, formatting the data into a proper format, and creating and storing an output image file. Retrieving network configuration and topological data can include communicating with a network configuration management system and other system to retrieve the network topology and configuration data. Retrieving the annotation rules can involve retrieving the rules from the database 415, the rule detailing what colors and shapes to used on what context and related information. Formatting the data can involve generating a DOT file for the selected firewall log records, the associated contexts, and related information. Creating the output image file may involve using a tool such as the Graphviz® tool by AT&T Corporation to generate an image file. DOT is a plain text language that is used to describe graphs that are readable to both humans and computer programs. The term DOT derives from the fact that DOT graph files typically have the file extension .dot. DOT has a well-defined grammar and a set of standard vocabulary that can be used to described a directed or undirected graph. DOT is part of the Graphviz® tool package.

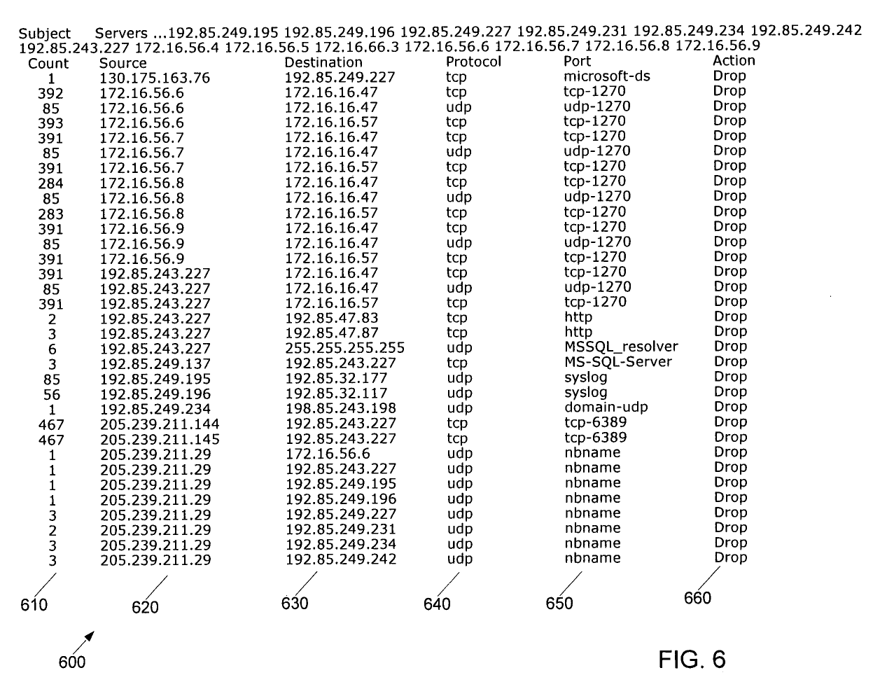

FIG. 6 shows an exemplary firewall log record summary report 600, in accordance with a disclosed embodiment. The firewall log record summary report 600 illustrates an example analysis that can be performed on the firewall log records. The firewall log record summary report 600 has six columns or fields: a count field 610, a source IP address field 620, a destination IP address field 630, a protocol field 640, a port field 650 and an action field 660. Each row or a record represents one or more attempts to access the private network the firewall is configured to protect. The count field 610 represents the number of access attempts. The source field 620 represents an IP address of the source node from which the access attempt of this record is originated. The destination field 630 represents an IP address of the destination node within the private network the access attempt is directed to. The protocol field 640 represents the protocol used for the access attempt, and the examples of the protocols include UDP and TCP. The port field 650 represents a port at the protocol layer, such as a UDP port or a TCP port, from which the access attempt originated. The port field 650 generally indicates the type of the application that initiated the access attempt, because the port numbers are standardized. For example, a web application uses the http port that is the TCP port 80. The action field 660 represents the action taken by the firewall. In the exemplary firewall log record summary report 600, the action is to drop the accessing packets for various reasons.

FIG. 6 also illustrates examples of analysis that may be preformed on the firewall log records. For example, there are a large number of attempts (391) from the source address 172.16.56.9 to access the destination node 172.16.16.47. The firewall log record manager 400 can determine the nature of access by checking the resources or applications on the node 172.16.16.47 that the access attempts were directed to. The fact that some of the other attempts are production interfaces attempting to communicate to management interfaces may suggest that there is a routing issue on the node 192.85.243.227 and the server 192.85.243.228. Also the node 192.85.249.137 attempted to perform MSSQL_server related communications to the nodes 192.85.243.227-228. This may suggest that additional firewall rules may be needed for this type of access because existing firewall rules do not have any information on this access. The attempts by the nodes 192.85.243.227-228 to communicate with MSSQL-resolver using the network IP subnet mask 255.255.255.2555 may suggest a possible application miscommunication. In sum, the above analysis may uncover potential issues with application configuration, server configuration, and firewall configuration.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for managing communication records, comprising:
receiving a plurality of firewall log records from at least a firewall system;
consolidating the plurality of firewall log records by filtering out a plurality of duplicate records;
associating the plurality of firewall log records with a plurality of contexts to create a plurality of record-context combinations;
analyzing and storing the consolidated firewall log records; and
producing at least one image file from the plurality of records-context combinations.

2. The method of claim 1, further comprising generating a list of a plurality of dropped firewall log records.

3. The method of claim 1, further comprising receiving the communication records from one or more of a firewall, sniffer, a router, a switch, a server and an intrusion detection system.

4. The method of claim 1, further comprising displaying the image files in at least one of a web browser and a stand-alone image display system.

5. The method of claim 1, wherein consolidating the firewall log records further comprises recognizing that a first firewall log record from a first source is the same as a second firewall log record from a second source, and discarding the second firewall log record.

6. The method of claim 1, wherein consolidating the firewall log records further comprises merging multiple firewall log records into one firewall log record.

7. The method of claim 1, wherein associating the firewall log records with the plurality of contexts comprises searching for a context for a firewall log record using an index field of the firewall log record.

8. The method of claim 1, where creating the plurality of image files comprises converting the records-context combinations into at least one DOT file and generating at least one image file.

9. The method of claim 8, wherein converting the records-context combinations into one or more of DOT files comprise one or more of representing a network node with an oval shape, a context with an octagon shape, a host computer with a rectangle shape, a subnet context with a white color, a demilitarized zone context with a green color, a compartment context with a blue color, an unknown context with a red color, a green link for an allowed access, and a red link for a denied access.

10. The method of claim 1, wherein analyzing the firewall log records further comprises identifying one or more of a traffic pattern, a misdirected packet, a firewall rule violation, a security rule violation, an error in naming network configuration, and an error in naming network equipment.

11. A system for managing firewall log records, comprising:
a memory operable to store a plurality of communication records, a plurality of contexts, and a plurality of network topology data; and
one or more processors collectively operable to:
receive the communication records from at least a communication system;
consolidate the communication records by filtering out a plurality of duplicate records;
associate the plurality of communication records with a plurality of contexts to create a plurality of record-context combinations;
analyze and store the consolidated communication records; and
produce at least one image file from the plurality of records-context combinations.

12. The system of claim 11, wherein the context further comprises a subnet context, a demilitarized zone context, a compartment context, and an unknown context.

13. The system of claim 11, wherein at least part of the system is implemented using one or more of shell script languages including a Bourne shell and programming languages including Java, C, and C++.

14. The system of claim 11, wherein the visual image file generator is implemented using a Graphviz tool.

15. The system of claim 11, wherein the firewall log record comprises an index field, a source IP address field, a destination IP address field, a server field, an organization field, a protocol field, a source port field, a destination port field, an action field, and an access attempt count field.

16. The system of claim 12, further comprising a database operable to manage the plurality of communication records, the plurality of contexts, and the at least one image file.

17. The system of claim 11, wherein the system is coupled to a communication system that is configured to generate the plurality of communication records.

18. The system of claim 11, wherein the system is coupled to a security management system configured to provide a set of security rules and a configuration management system configured to provide a plurality of network configuration data.

19. A computer program embodied on a computer readable medium and operable to be executed by a processor, the computer program comprising computer readable program code for:
receiving a plurality of firewall log records from at least one firewall system;
consolidating the firewall log records by filtering out a plurality of duplicate records;
associating the plurality of firewall log records with a plurality of contexts to create a plurality of record-context combinations;
analyzing and storing the consolidated firewall log records; and
producing at least one image file from the plurality of records-context combinations.

20. The computer program of claim 19, wherein the computer program further comprise computer readable program code for
a firewall log analyzer configured to analyze the consolidated firewall log records;
a firewall log record filter configured to consolidate the firewall log records, to associate the plurality of firewall log records with the plurality of contexts, and to create the plurality of record-context combinations; and
an image file generator configured to produce the plurality of image files from the plurality of records-context combinations.
